(19) United States
(12) Patent Application Publication
(10) Pub. No.: US 2025/0106456 A1
(43) Pub. Date: Mar. 27, 2025

(54) SYSTEM AND METHOD FOR STREAM DISTRIBUTION

(71) Applicant: 17LIVE Japan INC., Tokyo (JP)

(72) Inventor: I-Yun LEE, Taipei City (TW)

(21) Appl. No.: 18/801,928

(22) Filed: Aug. 13, 2024

(30) Foreign Application Priority Data
Sep. 21, 2023 (JP) 2023-154207

(51) Int. Cl. H04N 21/258; H04N 21/2187

(52) U.S. Cl. CPC H04N 21/25875; H04N 21/2187

(57) ABSTRACT

The present disclosure relates to a system and a method for stream distribution. The method includes: comparing a first parameter associated between a distributor and a viewer with a first threshold; comparing a second parameter associated between the distributor and the viewer with a second threshold; and determining the viewer to be eligible or not for viewing a live stream performed by the distributor according to results of the above comparisons.

### CROSS-REFERENCE TO RELATED APPLICATIONS

This application is based on and claims the benefit of priority from Japanese Patent Application Serial No. 2023-154207 (filed on Sep. 21, 2023), the contents of which are hereby incorporated by reference in their entirety.

### BACKGROUND OF THE DISCLOSURE

### Technical Field

The present disclosure relates to stream distribution and, more particularly, to live stream distribution.

### Description of Related Art

Real time interaction on the Internet, such as live streaming service, has become popular in our daily life. There are various platforms or providers providing the service of live streaming, and the competition is fierce. It is important for a platform to provide its users their desired services.

Taiwan patent application publication TW201832576 discloses a method for actively constructing a real-time interaction group on the Internet.

### SUMMARY OF THE DISCLOSURE

A method according to one embodiment of the present disclosure is a method for stream distribution being executed by one or a plurality of computers, and includes: comparing a first parameter associated between a distributor and a viewer with a first threshold; comparing a second parameter associated between the distributor and the viewer with a second threshold; and determining the viewer to be eligible or not for viewing a live stream performed by the distributor according to results of the above comparisons.

A system according to one embodiment of the present disclosure is a system for stream distribution that includes one or a plurality of processors, and the one or plurality of processors execute a machine-readable instruction to perform: comparing a first parameter associated between a distributor and a viewer with a first threshold; comparing a second parameter associated between the distributor and the viewer with a second threshold; and determining the viewer to be eligible or not for viewing a live stream performed by the distributor according to results of the above comparisons.

A non-transitory computer-readable medium including a program for stream distribution, wherein the program causes one or a plurality of computers to execute: comparing a first parameter associated between a distributor and a viewer with a first threshold; comparing a second parameter associated between the distributor and the viewer with a second threshold; and determining the viewer to be eligible or not for viewing a live stream performed by the distributor according to results of the above comparisons.

### BRIEF DESCRIPTION OF THE DRAWINGS

FIG. 1 shows a schematic configuration of a live streaming system 1 according to some embodiments of the present disclosure.

FIG. 2 is a block diagram showing functions and configuration of the user terminal 30 of FIG. 1 according to some embodiments of the present disclosure.

FIG. 3 shows a block diagram illustrating functions and configuration of the server 10 of FIG. 1 according to some embodiments of the present disclosure.

FIG. 4 is a data structure diagram of an example of the stream DB 310 of FIG. 3.

FIG. 5 is a data structure diagram showing an example of the user DB 312 of FIG. 3.

FIG. 6 is a data structure diagram showing an example of the gift DB 314 of FIG. 3.

FIG. 7 shows a block diagram illustrating functions and configuration of the server 10 of FIG. 1 according to some embodiments of the present disclosure.

FIG. 8 is a data structure diagram showing an example of the interaction parameter DB 330.

FIG. 9 is a data structure diagram showing an example of the eligible viewer DB 332.

FIG. 10 shows an exemplary flow according to some embodiments of the present disclosure.

FIG. 11 shows an exemplary user interface at the distributor side according to some embodiments of the present disclosure.

FIG. 12 shows an exemplary recommendation page at the viewer side according to some embodiments of the present disclosure.

FIG. 13 is a data structure diagram showing an example of the confidence score DB 334.

FIG. 14 is a block diagram showing an example of a hardware configuration of the information processing device according to some embodiments of the present disclosure.

### DETAILED DESCRIPTION

Hereinafter, the identical or similar components, members, procedures or signals shown in each drawing are referred to with like numerals in all the drawings, and thereby an overlapping description is appropriately omitted. Additionally, a portion of a member which is not important in the explanation of each drawing is omitted.

A distributor (or streamer) on a streaming platform would like to keep good interaction with viewers to achieve higher rewards. A distributor may want to interact with as many viewers as possible and let all viewers enjoy and be involved in the interaction. However, low-key (or inactive) viewers who rarely interact may be adversely affected by high-key (or active) viewers who interact frequently. For example, a low-key viewer may not know how or when to comment in a stream room if other high-key viewers keep commenting. Therefore, a method or a system to encourage low-key viewers to interact is desirable.

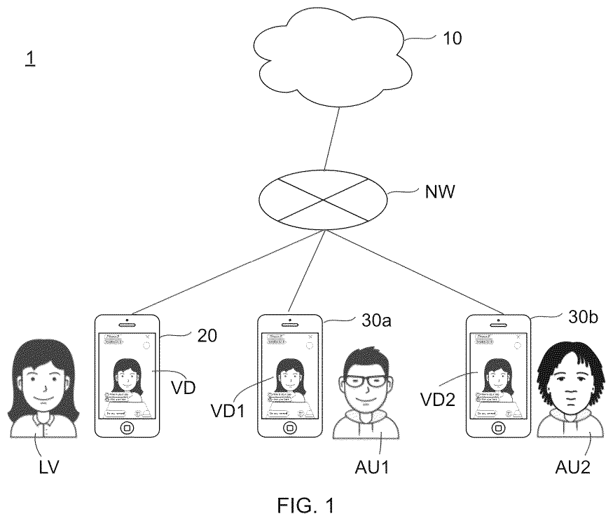

FIG. 1 shows a schematic configuration of a live streaming system 1 according to some embodiments of the present disclosure. The live streaming system 1 provides a live streaming service for the streaming streamer (could be referred to as liver, anchor, distributor, or livestreamer) LV and viewer (could be referred to as audience) AU (AU1, AU2 . . . ) to interact or communicate in real time. As shown in FIG. 1, the live streaming system 1 includes a server 10, a user terminal 20 and user terminals 30 (30a, 30b . . . ). In some embodiments, the streamers and viewers may be collectively referred to as users. The server 10 may include one or a plurality of information processing devices connected to a network NW. The user terminal 20 and 30 may be, for example, mobile terminal devices such as smartphones, tablets, laptop PCs, recorders, portable gaming devices, and wearable devices, or may be stationary devices such as desktop PCs. The server 10, the user terminal 20 and the user terminal 30 are interconnected so as to be able to communicate with each other over the various wired or wireless networks NW.

The live streaming system 1 involves the distributor LV, the viewers AU, and an administrator (or an APP provider, not shown) who manages the server 10. The distributor LV is a person who broadcasts contents in real time by recording the contents with his/her user terminal 20 and uploading them directly or indirectly to the server 10. Examples of the contents may include the distributor's own songs, talks, performances, gameplays, and any other contents. The administrator provides a platform for live-streaming contents on the server 10, and also mediates or manages real-time interactions between the distributor LV and the viewers AU. The viewer AU accesses the platform at his/her user terminal 30 to select and view a desired content. During live-streaming of the selected content, the viewer AU performs operations to comment, cheer, or send gifts via the user terminal 30. The distributor LV who is delivering the content may respond to such comments, cheers, or gifts. The response is transmitted to the viewer AU via video and/or audio, thereby establishing an interactive communication.

The term “live-streaming” may mean a mode of data transmission that allows a content recorded at the user terminal 20 of the distributor LV to be played or viewed at the user terminals 30 of the viewers AU substantially in real time, or it may mean a live broadcast realized by such a mode of transmission. The live-streaming may be achieved using existing live delivery technologies such as HTTP Live Streaming, Common Media Application Format, Web Real-Time Communications, Real-Time Messaging Protocol and MPEG DASH. Live-streaming includes a transmission mode in which the viewers AU can view a content with a specified delay simultaneously with the recording of the content by the distributor LV. As for the length of the delay, it may be acceptable for a delay with which interaction between the distributor LV and the viewers AU can be established. Note that the live-streaming is distinguished from so-called on-demand type transmission, in which the entire recorded data of the content is once stored on the server, and the server provides the data to a user at any subsequent time upon request from the user.

The term “video data” herein refers to data that includes image data (also referred to as moving image data) generated using an image capturing function of the user terminals 20 or 30, and audio data generated using an audio input function of the user terminals 20 or 30. Video data is reproduced in the user terminals 20 and 30, so that the users can view contents. In some embodiments, it is assumed that between video data generation at the distributor's user terminal and video data reproduction at the viewer's user terminal, processing is performed onto the video data to change its format, size, or specifications of the data, such as compression, decompression, encoding, decoding, or transcoding. However, the content (e.g., video images and audios) represented by the video data before and after such processing does not substantially change, so that the video data after such processing is herein described as the same as the video data before such processing. In other words, when video data is generated at the distributor's user terminal and then played back at the viewer's user terminal via the server 10, the video data generated at the distributor's user terminal, the video data that passes through the server 10, and the video data received and reproduced at the viewer's user terminal are all the same video data.

In the example in FIG. 1, the distributor LV provides the live streaming data. The user terminal 20 of the distributor LV generates the streaming data by recording images and sounds of the distributor LV, and the generated data is transmitted to the server 10 over the network NW. At the same time, the user terminal 20 displays a recorded video image VD of the distributor LV on the display of the user terminal 20 to allow the distributor LV to check the live streaming contents currently performed.

The user terminals 30a and 30b of the viewers AU1 and AU2 respectively, who have requested the platform to view the live streaming of the distributor LV, receive video data related to the live streaming (may also be herein referred to as “live-streaming video data”) over the network NW and reproduce the received video data to display video images VD1 and VD2 on the displays and output audio through the speakers. The video images VD1 and VD2 displayed at the user terminals 30a and 30b, respectively, are substantially the same as the video image VD captured by the user terminal 20 of the distributor LV, and the audio outputted at the user terminals 30a and 30b is substantially the same as the audio recorded by the user terminal 20 of the distributor LV.

Recording of the images and sounds at the user terminal 20 of the distributor LV and reproduction of the video data at the user terminals 30a and 30b of the viewers AU1 and AU2 are performed substantially simultaneously. Once the viewer AU1 types a comment about the contents provided by the distributor LV on the user terminal 30a, the server 10 displays the comment on the user terminal 20 of the distributor LV in real time and also displays the comment on the user terminals 30a and 30b of the viewers AU1 and AU2, respectively. When the distributor LV reads the comment and develops his/her talk to cover and respond to the comment, the video and sound of the talk are displayed on the user terminals 30a and 30b of the viewers AU1 and AU2, respectively. This interactive action is recognized as the establishment of a conversation between the distributor LV and the viewer AU1. In this way, the live streaming system 1 realizes the live streaming that enables interactive communication, not one-way communication.

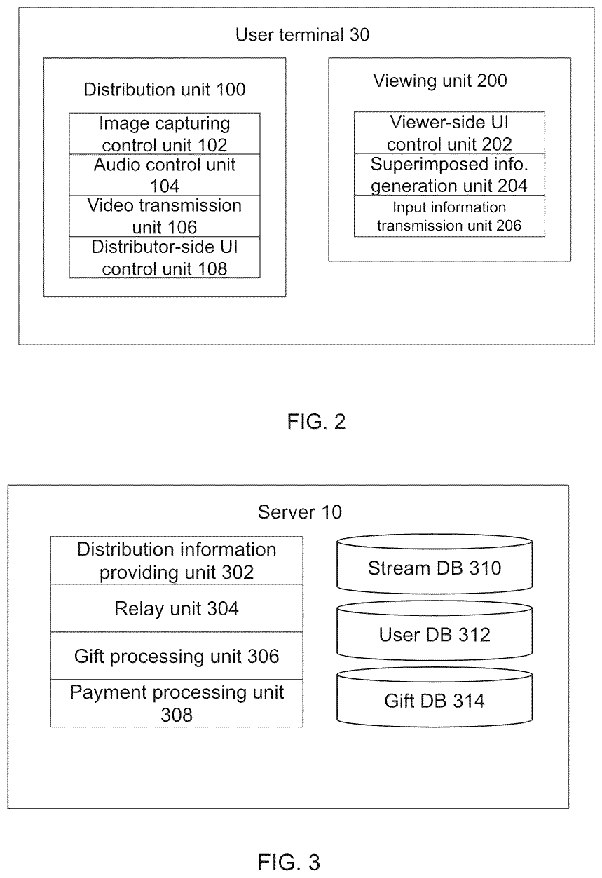

FIG. 2 is a block diagram showing functions and configuration of the user terminal 30 of FIG. 1 according to some embodiments of the present disclosure. The user terminal 20 has the same or similar functions and configuration as the user terminal 30. Each block in FIG. 2 and the subsequent block diagrams may be realized by elements such as a computer CPU or a mechanical device in terms of hardware, and can be realized by a computer program or the like in terms of software. Functional blocks could be realized by cooperative operation between these elements. Therefore, it is understood by those skilled in the art that these functional blocks can be realized in various forms by combining hardware and software.

The distributor LV and the viewers AU may download and install a live streaming application program (hereinafter referred to as a live streaming application) to the user terminals 20 and 30 from a download site over the network NW. Alternatively, the live streaming application may be pre-installed on the user terminals 20 and 30. When the live streaming application is executed on the user terminals 20 and 30, the user terminals 20 and 30 communicate with the server 10 over the network NW to implement or execute various functions. Hereinafter, the functions implemented by the user terminals 20 and 30 (processors such as CPUs) in which the live streaming application is run will be described as functions of the user terminals 20 and 30. These functions are realized in practice by the live streaming application on the user terminals 20 and 30. In some embodiments, these functions may be realized by a computer program that is written in a programming language such as HTML (HyperText Markup Language), transmitted from the server 10 to web browsers of the user terminals 20 and 30 over the network NW, and executed by the web browsers.

The user terminal 30 includes a distribution unit 100 and a viewing unit 200. The distribution unit 100 generates video data in which the user's (or the user side's) image and sound are recorded, and provides the video data to the server 10. The viewing unit 200 receives video data from the server 10 to reproduce the video data. The user activates the distribution unit 100 when the user performs live streaming, and activates the viewing unit 200 when the user views a video. The user terminal in which the distribution unit 100 is activated is the distributor's terminal, i.e., the user terminal that generates the video data. The user terminal in which the viewing unit 200 is activated is the viewer's terminal, i.e., the user terminal in which the video data is reproduced and played.

The distribution unit 100 includes an image capturing control unit 102, an audio control unit 104, a video transmission unit 106, and a distribution-side Ul control unit 108. The image capturing control unit 102 is connected to a camera (not shown in FIG. 2) and controls image capturing performed by the camera. The image capturing control unit 102 obtains image data from the camera. The audio control unit 104 is connected to a microphone (not shown in FIG. 2) and controls audio input from the microphone. The audio control unit 104 obtains audio data through the microphone. The video transmission unit 106 transmits video data including the image data obtained by the image capturing control unit 102 and the audio data obtained by the audio control unit 104 to the server 10 over the network NW. The video data is transmitted by the video transmission unit 106 in real time. That is, the generation of the video data by the image capturing control unit 102 and the audio control unit 104, and the transmission of the generated video data by the video transmission unit 106 are performed substantially at the same time. The distribution-side Ul control unit 108 controls an Ul (user interface) for the distributor. The distribution-side Ul control unit 108 may be connected to a display (not shown in FIG. 2), and displays a video on the display by reproducing the video data that is to be transmitted by the video transmission unit 106. The distribution-side Ul control unit 108 may display an operation object or an instruction-accepting object on the display, and accepts inputs from the distributor who taps on the object.

The viewing unit 200 includes a viewer-side UI control unit 202, a superimposed information generation unit 204, and an input information transmission unit 206. The viewing unit 200 receives, from the server 10 over the network NW, video data related to the live streaming in which the distributor, the viewer who is the user of the user terminal 30, and other viewers participate. The viewer-side UI control unit 202 controls the UI for the viewers. The viewer-side UI control unit 202 is connected to a display and a speaker (not shown in FIG. 2), and reproduces the received video data to display video images on the display and output audio through the speaker. The state where the image is outputted to the display and the audio is outputted from the speaker can be referred to as “the video data is played”. The viewer-side UI control unit 202 is also connected to input means (not shown in FIG. 2) such as touch panels, keyboards, and displays, and obtains user input via these input means. The superimposed information generation unit 204 superimposes a predetermined frame image on an image generated from the video data from the server 10. The frame image includes various user interface objects (hereinafter simply referred to as “objects”) for accepting inputs from the user, comments entered by the viewers, and/or information obtained from the server 10. The input information transmission unit 206 transmits the user input obtained by the viewer-side UI control unit 202 to the server 10 over the network NW.

FIG. 3 shows a block diagram illustrating functions and configuration of the server 10 of FIG. 1 according to some embodiments of the present disclosure. The server 10 includes a distribution information providing unit 302, a relay unit 304, a gift processing unit 306, a payment processing unit 308, a stream DB 310, a user DB 312, and a gift DB 314.

Upon reception of a notification or a request from the user terminal 20 on the distributor side to start a live streaming over the network NW, the distribution information providing unit 302 registers a stream ID for identifying this live streaming and the distributor ID of the distributor who performs the live streaming in the stream DB 310.

When the distribution information providing unit 302 receives a request to provide information about live streams from the viewing unit 200 of the user terminal 30 on the viewer side over the network NW, the distribution information providing unit 302 retrieves or checks currently available live streams from the stream DB 310 and makes a list of the available live streams. The distribution information providing unit 302 transmits the generated list to the requesting user terminal 30 over the network NW. The viewer-side UI control unit 202 of the requesting user terminal 30 generates a live stream selection screen based on the received list and displays it on the display of the user terminal 30.

Once the input information transmission unit 206 of the user terminal 30 receives the viewer's selection result on the live stream selection screen, the input information transmission unit 206 generates a distribution request including the stream ID of the selected live stream, and transmits the request to the server 10 over the network NW. The distribution information providing unit 302 starts providing, to the requesting user terminal 30, the live stream specified by the stream ID included in the received distribution request. The distribution information providing unit 302 updates the stream DB 310 to include the user ID of the viewer of the requesting user terminal 30 into the viewer IDs of (or corresponding to) the stream ID.

The relay unit 304 relays the video data from the distributor-side user terminal 20 to the viewer-side user terminal 30 in the live streaming started by the distribution information providing unit 302. The relay unit 304 receives from the input information transmission unit 206 a signal that represents user input by a viewer during the live streaming or reproduction of the video data. The signal that represents user input may be an object specifying signal for specifying an object displayed on the display of the user terminal 30. The object specifying signal may include the viewer ID of the viewer, the distributor ID of the distributor of the live stream that the viewer watches, and an object ID that identifies the object. When the object is a gift, the object ID is the gift ID. Similarly, the relay unit 304 receives, from the distribution unit 100 of the user terminal 20, a signal that represents user input performed by the distributor during reproduction of the video data (or during the live streaming). The signal could be an object specifying signal.

Alternatively, the signal that represents user input may be a comment input signal including a comment entered by a viewer into the user terminal 30 and the viewer ID of the viewer. Upon reception of the comment input signal, the relay unit 304 transmits the comment and the viewer ID included in the signal to the user terminal 20 of the distributor and the user terminals 30 of other viewers. In these user terminals 20 and 30, the viewer-side UI control unit 202 and the superimposed information generation unit 204 display the received comment on the display in association with the viewer ID also received.

The gift processing unit 306 updates the user DB 312 so as to increase the points of the distributor depending on the points of the gift identified by the gift ID included in the object specifying signal. Specifically, the gift processing unit 306 refers to the gift DB 314 to specify the points to be granted for the gift ID included in the received object specifying signal. The gift processing unit 306 then updates the user DB 312 to add the determined points to the points of (or corresponding to) the distributor ID included in the object specifying signal.

The payment processing unit 308 processes payment of a price of a gift from a viewer in response to reception of the object specifying signal. Specifically, the payment processing unit 308 refers to the gift DB 314 to specify the price points of the gift identified by the gift ID included in the object specifying signal. The payment processing unit 308 then updates the user DB 312 to subtract the specified price points from the points of the viewer identified by the viewer ID included in the object specifying signal.

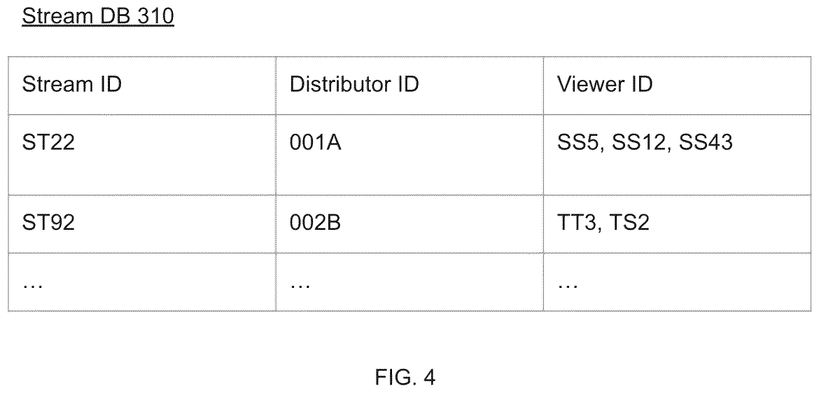

FIG. 4 is a data structure diagram of an example of the stream DB 310 of FIG. 3. The stream DB 310 holds information regarding a live stream currently taking place. The stream DB 310 stores the stream ID, the distributor ID, and the viewer ID, in association with each other. The stream ID is for identifying a live stream on a live streaming platform provided by the live streaming system 1. The distributor ID is a user ID for identifying the distributor who provides the live stream. The viewer ID is a user ID for identifying a viewer of the live stream. In the live streaming platform provided by the live streaming system 1 of some embodiments, when a user starts a live stream, the user becomes a distributor, and when the same user views a live stream broadcast by another user, the user also becomes a viewer. Therefore, the distinction between a distributor and a viewer is not fixed, and a user ID registered as a distributor ID at one time may be registered as a viewer ID at another time.

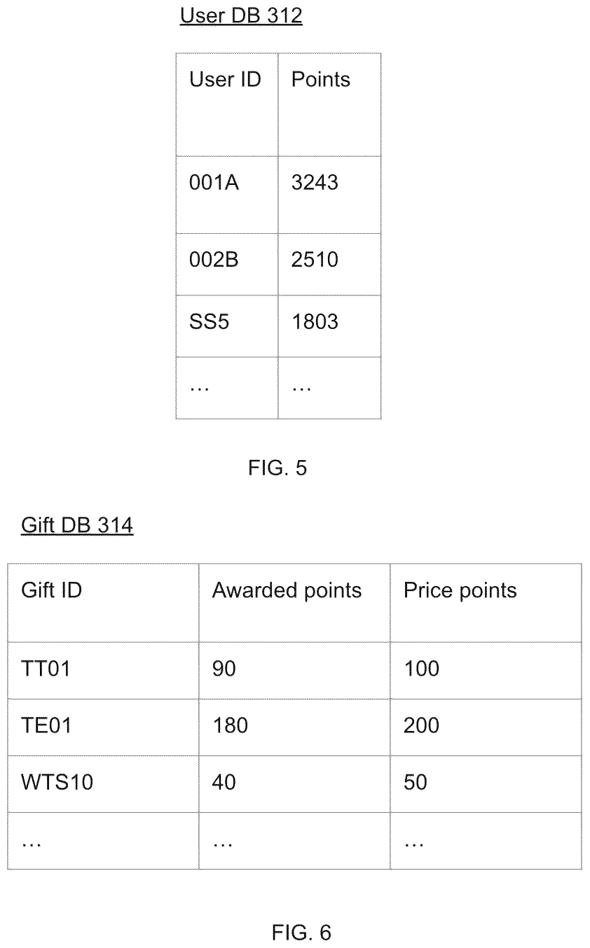

FIG. 5 is a data structure diagram showing an example of the user DB 312 of FIG. 3. The user DB 312 holds information regarding users. The user DB 312 stores the user ID and the point, in association with each other. The user ID identifies a user. The point corresponds to the points the corresponding user holds. The point is the electronic value circulated within the live streaming platform. In some embodiments, when a distributor receives a gift from a viewer during a live stream, the distributor's points increase by the value corresponding to the gift. The points are used, for example, to determine the amount of reward (such as money) the distributor receives from the administrator of the live streaming platform. In some embodiments, when the distributor receives a gift from a viewer, the distributor may be given the amount of money corresponding to the gift instead of the points.

FIG. 6 is a data structure diagram showing an example of the gift DB 314 of FIG. 3. The gift DB 314 holds information regarding gifts available for the viewers in the live streaming. A gift is electronic data. A gift may be purchased with the points or money, or can be given for free. A gift may be given by a viewer to a distributor. Giving a gift to a distributor is also referred to as using, sending, or throwing the gift. Some gifts may be purchased and used at the same time, and some gifts may be purchased and then used at any time later by the purchaser viewer. When a viewer gives a gift to a distributor, the distributor is awarded the amount of points corresponding to the gift. When a gift is used, the use may trigger an effect associated with the gift. For example, an effect (such as visual or sound effect) corresponding to the gift will appear on the live streaming screen.

The gift DB 314 stores the gift ID, the awarded points, and the price points, in association with each other. The gift ID is for identifying a gift. The awarded points are the amount of points awarded to a distributor when the gift is given to the distributor. The price points are the amount of points to be paid for use (or purchase) of the gift. A viewer is able to give a desired gift to a distributor by paying the price points of the desired gift when the viewer is viewing the live stream. The payment of the price points may be made by an appropriate electronic payment means. For example, the payment may be made by the viewer paying the price points to the administrator. Alternatively, bank transfers or credit card payments may be used. The administrator is able to desirably set the relationship between the awarded points and the price points. For example, it may be set as the awarded points=the price points. Alternatively, points obtained by multiplying the awarded points by a predetermined coefficient such as 1.2 may be set as the price points, or points obtained by adding predetermined fee points to the awarded points may be set as the price points.

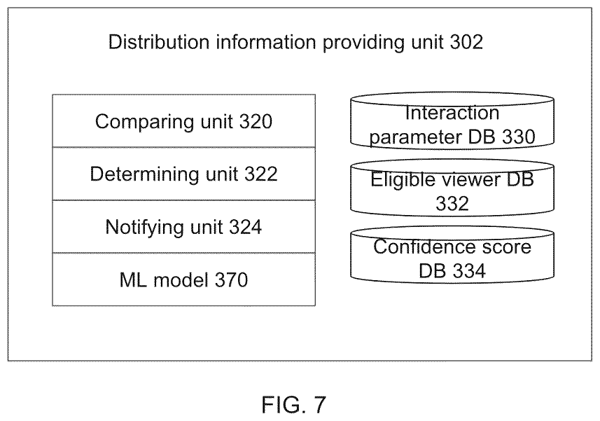

FIG. 7 shows a block diagram illustrating exemplary functions and configurations of the distribution information providing unit 302 of FIG. 3 according to some embodiments of the present disclosure. In some embodiments, the distribution information providing unit 302 is configured to suppress participation of high-key viewers in a live stream of a live streamer by segmenting viewers of the live streamer into high-key viewers and low-key viewers and prohibiting the high-key viewers from finding the live stream of the live streamer. The distribution information providing unit 302 includes a comparing unit 320, a determining unit 322, a notifying unit 324, an interaction parameter DB 330, an eligible viewer DB 332, a confidence score DB 334 and a ML model 370. The ML model 370 includes one or more machine learning algorithms. In some embodiments, the ML model 370 could be implemented outside the distribution information providing unit 302 or the server 10.

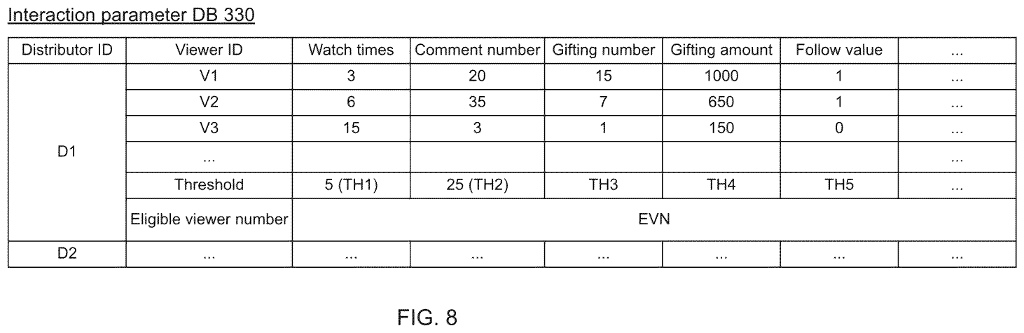

FIG. 8 is a data structure diagram showing an example of the interaction parameter DB 330. The interaction parameter DB 330 stores the distributor ID, the viewer ID, the interaction parameters, the respective thresholds, and the eligible viewer number, in association with each other.

The interaction parameters include parameters such as watch times, comment number, gifting number, gifting amount (or total gifting value), and follow value. Each interaction parameter is associated between a viewer and a distributor. The value of a parameter could be a historically accumulated value. For example, the watch time could be a historical number of watch times. For example, viewer V1 has watched streaming of distributor D1 for 3 times in total (the streaming could be associated with one stream ID or different stream IDs). Viewer V1 has commented 20 times in streaming of distributor D1 in total (in one stream or in several streams provided by distributor D1).

The “follow value” indicates whether or not the viewer has followed the distributor. A value of zero indicates the viewer is not yet a follower of the distributor. A value of one indicates the viewer is already a follower of the distributor.

The threshold (or threshold value) for an interaction parameter is used to determine low-key or high-key viewers with respect to that interaction parameter. For example, if TH2 is set to 25, viewer V1 (who has the comment number 20) is considered to be a low-key viewer for distributor D1, and viewer V2 (who has the comment number 35) is considered to be a high-key viewer for distributor D1, in the comment aspect. For example, if TH5 is set to 0.5, viewer V1 (who has the follow value 1) is considered to be a high-key viewer for distributor D1, and viewer V3 (who has the follow value 0) is considered to be a low-key viewer for distributor D1, in the “follow” aspect. The threshold value of each interaction parameter could be set according to practical application or desirable focus items of the operator of the streaming platform.

The eligible viewer number EVN is the number of viewers who are eligible to watch (or to receive notification about) a new live stream provided by distributor D1. In some embodiments, the eligible viewers are viewers who have [watch times greater than or equal to TH1] and are [low-key in other interaction parameters]. In some embodiments, the eligible viewers are viewers who have [watch times greater than or equal to TH1] and are [low-key in at least another one interaction parameter]. In some embodiments, [watch times greater than or equal to TH1] indicates the viewer is interested in (or, may want to interact with) the distributor. But that viewer may not know how or when to interact in normal-mode stream rooms, wherein other high-key viewers also exist.

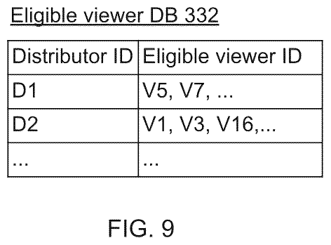

FIG. 9 is a data structure diagram showing an example of the eligible viewer DB 332. The eligible viewer DB 332 stores the distributor ID and the eligible viewer ID, in association with each other. The eligible viewers are identified according to the interaction parameters and the threshold values in the interaction parameter DB 330. The identification could be performed by the comparing unit 320 and/or the determining unit 322. The number of the eligible viewers for each distributor could be stored into the interaction parameter DB 330, by the determining unit 322, for example.

The comparing unit 320 is configured to compare an interaction parameter with a corresponding threshold value. For example, the comparing unit 320 is configured to compare the “watch times” associated between viewer V3 and distributor D1 with the threshold TH1 in FIG. 8. For example, the comparing unit 320 is configured to compare the “comment number” associated between viewer V3 and distributor D1 with the threshold TH2 in FIG. 8.

The determining unit 322 is configured to determine a viewer to be eligible or not for viewing a live stream performed by a distributor according to results of the above comparisons. For example, in the embodiment of FIG. 8, the determining unit 322 may determine viewer V3 to be eligible for viewing a live stream performed (or to be performed) by distributor D1 when (or after): the comparing unit 320 determines the “watch times” (associated between viewer V3 and distributor D1) to be greater than TH1 and determines the “comment number” (associated between viewer V3 and distributor D1) to be less than threshold TH2. Viewer V3 may be a low-key viewer who is interested in distributor D1 (watch times>TH1) but may not know how or when to interact (comment number<TH2) in a normal-mode stream room wherein the distributor may need to interact with other high-key viewers.

For example, in the embodiment of FIG. 8, the determining unit 322 may determine viewer V2 to be not eligible for viewing a live stream performed (or to be performed) by distributor D1 when (or after): the comparing unit 320 determines the “watch times” (associated between viewer V2 and distributor D1) to be greater than TH1 and determines the “comment number” (associated between viewer V2 and distributor D1) to be greater than threshold TH2. Viewer V2 may be considered to be a high-key viewer for distributor D1.

The notifying unit 324 is configured to notify a viewer about a start of a live stream performed by a distributor. For example, the notifying unit 324 may notify viewer V3 about a start of a live stream performed (or to be performed) by distributor D1, after the determining unit 322 determines viewer V3 to be an eligible viewer for distributor D1.

In some embodiments, the notifying unit 324 is configured to prevent a viewer from receiving a notification about a start of a live stream performed by a distributor. For example, the notifying unit 324 may prevent viewer V2 from receiving a notification about a start of a live stream performed (or to be performed) by distributor D1, after the determining unit 322 determines viewer V2 to be a non-eligible viewer for distributor D1. Therefore, only eligible viewers (or low-key viewers) can receive the notification and join the stream. The distributor can focus on interacting with low-key viewers and encourage them to interact more.

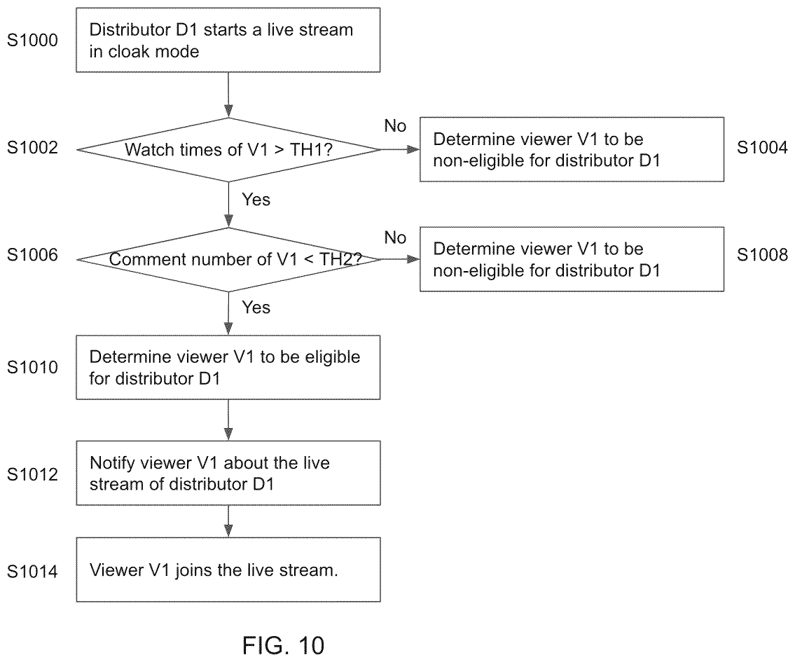

FIG. 10 shows an exemplary flow according to some embodiments of the present disclosure.

At step S1000, distributor D1 starts a live stream in cloak mode. A “cloak mode” is a stream mode wherein only eligible viewers (or low-key viewers) can join and/or only eligible viewers (or low-key viewers) can be notified.

At step S1002, the comparing unit 320 determines whether or not the watch times of viewer V1 with respect to distributor D1 is greater than the threshold TH1. If yes, the flow goes to step S1006. If not, the flow goes to step S1004.

At step S1004, the determining unit 322 determines viewer V1 to be non-eligible for the cloak mode of distributor D1. Because the watch times are still low, we cannot confirm if viewer V1 is interested in distributor D1 or not.

At step S1006, the comparing unit 320 determines whether or not the comment number of viewer V1 with respect to distributor D1 is less than the threshold TH2. If yes, the flow goes to step S1010. If not, the flow goes to step S1008.

At step S1008, the determining unit 322 determines viewer V1 to be non-eligible for the cloak mode of distributor D1. Because the comment number is not less than TH2, viewer V1 may already be an active or high-key viewer for distributor D1. An active or high-key viewer is not the target of cloak mode streaming.

At step S1010, the determining unit 322 determines viewer V1 to be eligible for the cloak mode stream of distributor D1.

At step S1012, the notifying unit 324 notifies viewer V1 about the live stream of distributor D1, such that viewer V1 can join. A third-party notification service may be utilized.

At step S1014, viewer V1 joins the cloak mode live stream.

Similar processes could be performed for all viewers (could be followers or non-followers of distributor D1, or could be viewers who have watched distributor D1's streaming in the past X days, in some embodiments).

In some embodiments, distributor D1 can set the desirable number (or number range, or maximum number) of viewers when starting a cloak mode stream. Distributor D1 may want to focus on a limited number of low-key viewers such that each viewer can have a good chance of interaction. The threshold value of each interaction parameter could be adjusted by the ML model 370 according to the desirable viewer number. For example, the ML model 370 may adjust the threshold value of “watch times” and the threshold value of “comment number” according to the watch times and the comment numbers of all viewers (or online viewers at the time of starting the live stream), such that only a limited number of viewers can be determined to be eligible for the cloak mode. In some embodiments, the ML model 370 can adjust the threshold values in a real time manner, according to the entering and leaving of each viewer, such that the number of viewers in the cloak mode can be maintained within a desirable range set by the distributor. The adjustment could be performed in various ways. For example, the threshold value of the “watch times” could be fixed first to filter out viewers who are not interested in the distributor, and the threshold values of other interaction parameters could be adjusted according to the desirable viewer number.

In some embodiments, only viewers who are eligible cloak mode viewers with respect to a distributor can see the distributor's cloak mode stream on a recommendation page of the streaming platform. In some embodiments, a viewer can choose to view only cloak mode streams (with respect to the viewer) in a recommendation page on the platform, such that he/she would not be bothered by other high-key (or active) viewers. Therefore, the cloak mode streams displayed on each viewer's recommendation page are different.

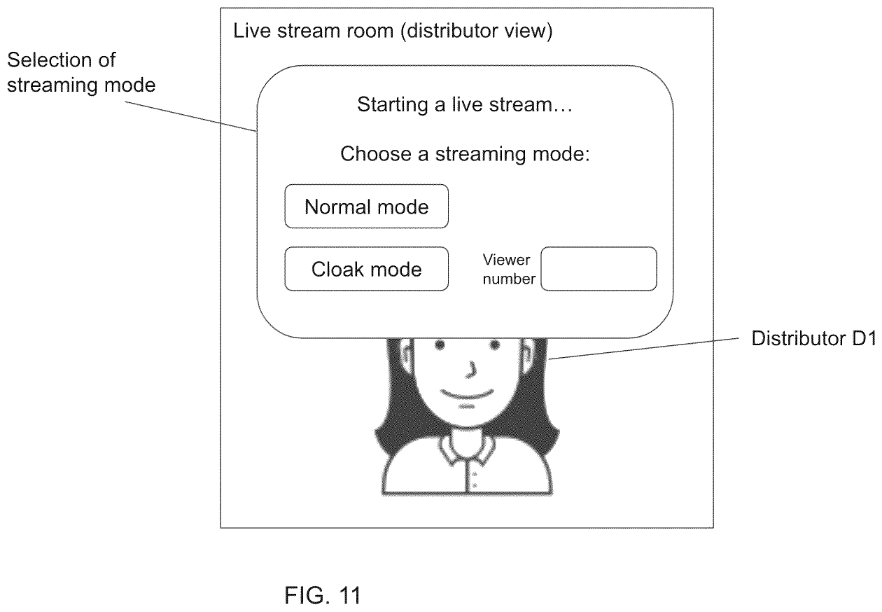

FIG. 11 shows an exemplary user interface at the distributor side according to some embodiments of the present disclosure.

When distributor D1 initiates a live stream, a chat box of streaming mode selection pops up. Distributor D1 can choose to stream in normal mode or in cloak mode. Distributor D1 can also enter a desirable viewer number if he/she wants to stream in cloak mode.

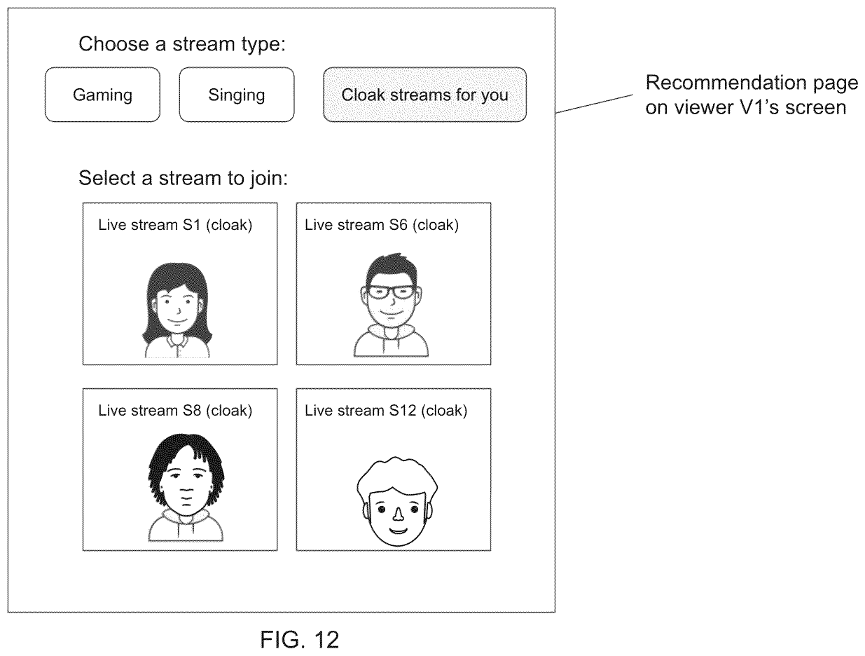

FIG. 12 shows an exemplary recommendation page at the viewer side according to some embodiments of the present disclosure.

Viewer V1 can choose different stream types, such as gaming, singing, or cloak mode streams, to see the corresponding recommended live streams. As shown in FIG. 12, viewer V1 clicked on the “cloak streams for you”, and streams that are in cloak mode and are available to viewer V1 (which means viewer V1 is an eligible viewer for those cloak mode streams) are displayed.

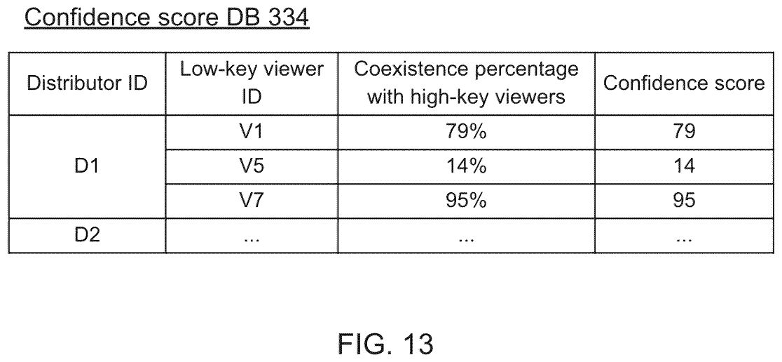

FIG. 13 is a data structure diagram showing an example of the confidence score DB 334. The confidence score DB 334 stores the distributor ID, the low-key viewer ID, the coexistence percentage with high-key viewers, and the confidence score, in association with each other.

The low-key viewers are the viewers who are identified as low-key viewers with respect to the corresponding distributor. For example, comment numbers of viewers V1, V5 and V7 with respect to distributor D1 are less than a comment number threshold.

The “coexistence percentage with high-key viewers” (or “coexistence percentage” for short) indicates how much the viewer spends time in the distributor's streaming with other high-key viewers. The coexistence percentage with high-key viewers could be [the time the viewer has spent in the distributor's streaming when other high-key viewers with respect to the distributor are also present] divided by [total time the viewer has spent in the distributor's streaming]. In some embodiments, the higher the percentage, the more liable that the viewer is a low-key viewer due to the adverse effect by other high-key viewers.

The confidence score is determined according to the coexistence percentage. The confidence score could be the same as the percentage or could be proportional to the percentage. The confidence score shows how confident we are to determine that a viewer is a low-key viewer due to the effects from other high-key viewers. In some embodiments, the confidence score could serve as the priority (higher score with higher priority) when distributing notifications to viewers when there is a viewer number limit in a cloak mode stream. In some embodiments, only low-key viewers with confidence scores higher than a confidence score threshold can join a cloak mode stream. In some embodiments, the coexistence percentage and the confidence score could be determined or calculated by the determining unit 322.

The distributor would like to invite the low-key viewers, who are low-key because of the adverse effects of other high-key viewers, to the cloak mode stream, such that the low-key viewers can interact more in a more comfortable environment. A low-key viewer with a low confidence score may indicate that the viewer tends to be low-key whether or not there are other high-key viewers, therefore the cloak mode stream may not encourage them to interact more.

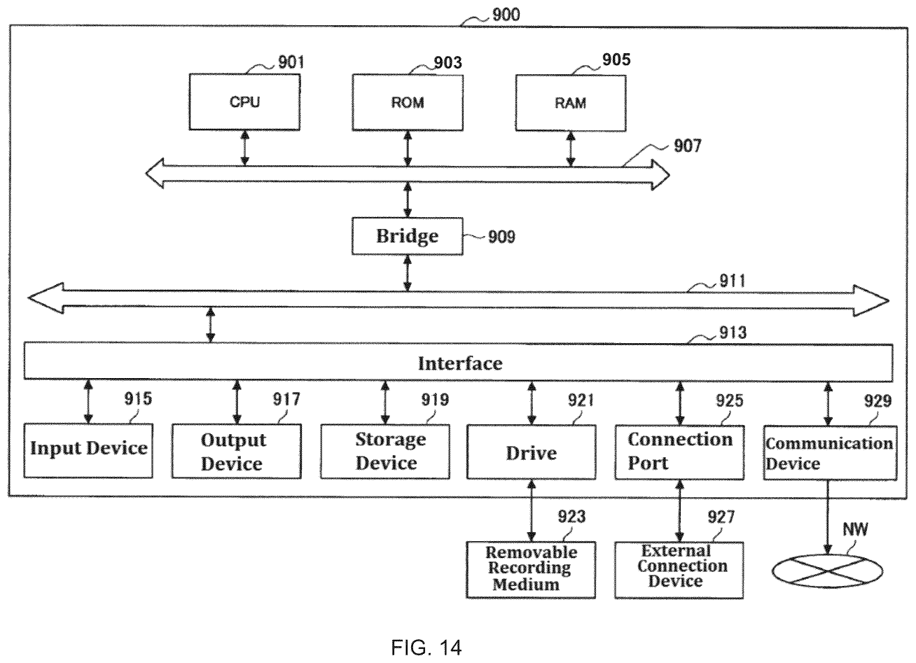

Referring to FIG. 14, the hardware configuration of the information processing device will be now described. FIG. 14 is a block diagram showing an example of a hardware configuration of the information processing device according to some embodiments of the present disclosure. The illustrated information processing device 900 may, for example, realize the server 10 and/or the user terminals 20 and 30 in some embodiments.

The information processing device 900 includes a CPU 901, ROM (Read Only Memory) 903, and RAM (Random Access Memory) 905. The information processing device 900 may also include a host bus 907, a bridge 909, an external bus 911, an interface 913, an input device 915, an output device 917, a storage device 919, a drive 921, a connection port 925, and a communication device 929. In addition, the information processing device 900 includes an image capturing device such as a camera (not shown). In addition to or instead of the CPU 901, the information processing device 900 may also include a DSP (Digital Signal Processor) or ASIC (Application Specific Integrated Circuit).

The CPU 901 functions as an arithmetic processing device and a control device, and controls all or some of the operations in the information processing device 900 according to various programs stored in the ROM 903, the RAM 905, the storage device 919, or the removable recording medium 923. For example, the CPU 901 controls the overall operation of each functional unit included in the server 10 and the user terminals 20 and 30 in some embodiments. The ROM 903 stores programs, calculation parameters, and the like used by the CPU 901. The RAM 905 serves as a primary storage that stores a program used in the execution of the CPU 901, parameters that appropriately change in the execution, and the like. The CPU 901, ROM 903, and RAM 905 are interconnected to each other by a host bus 907 which may be an internal bus such as a CPU bus. Further, the host bus 907 is connected to an external bus 911 such as a PCI (Peripheral Component Interconnect/Interface) bus via a bridge 909.

The input device 915 may be a user-operated device such as a mouse, keyboard, touch panel, buttons, switches and levers, or a device that converts a physical quantity into an electric signal such as a sound sensor typified by a microphone, an acceleration sensor, a tilt sensor, an infrared sensor, a depth sensor, a temperature sensor, a humidity sensor, and the like. The input device 915 may be, for example, a remote control device utilizing infrared rays or other radio waves, or an external connection device 927 such as a mobile phone compatible with the operation of the information processing device 900. The input device 915 includes an input control circuit that generates an input signal based on the information inputted by the user or the detected physical quantity and outputs the input signal to the CPU 901. By operating the input device 915, the user inputs various data and instructs operations to the information processing device 900.

The output device 917 is a device capable of visually or audibly informing the user of the obtained information. The output device 917 may be, for example, a display such as an LCD, PDP, or OLED, etc., a sound output device such as a speaker and headphones, and a printer. The output device 917 outputs the results of processing by the information processing device 900 as text, video such as images, or sound such as audio.

The storage device 919 is a device for storing data configured as an example of a storage unit of the information processing device 900. The storage device 919 is, for example, a magnetic storage device such as a hard disk drive (HDD), a semiconductor storage device, an optical storage device, or an optical magnetic storage device. This storage device 919 stores programs executed by the CPU 901, various data, and various data obtained from external sources.

The drive 921 is a reader/writer for a removable recording medium 923 such as a magnetic disk, an optical disk, a photomagnetic disk, or a semiconductor memory, and is built in or externally attached to the information processing device 900. The drive 921 reads information recorded in the mounted removable recording medium 923 and outputs it to the RAM 905. Further, the drive 921 writes records in the attached removable recording medium 923.

The connection port 925 is a port for directly connecting a device to the information processing device 900. The connection port 925 may be, for example, a USB (Universal Serial Bus) port, an IEEE1394 port, an SCSI (Small Computer System Interface) port, or the like. Further, the connection port 925 may be an RS-232C port, an optical audio terminal, an HDMI (registered trademark) (High-Definition Multimedia Interface) port, or the like. By connecting the external connection device 927 to the connection port 925, various data can be exchanged between the information processing device 900 and the external connection device 927.

The communication device 929 is, for example, a communication interface formed of a communication device for connecting to the network NW. The communication device 929 may be, for example, a communication card for a wired or wireless LAN (Local Area Network), Bluetooth (trademark), or WUSB (Wireless USB). Further, the communication device 929 may be a router for optical communication, a router for ADSL (Asymmetric Digital Subscriber Line), a modem for various communications, or the like. The communication device 929 transmits and receives signals and the like over the Internet or to and from other communication devices using a predetermined protocol such as TCP/IP. The communication network NW connected to the communication device 929 is a network connected by wire or wirelessly, and is, for example, the Internet, home LAN, infrared communication, radio wave communication, satellite communication, or the like. The communication device 929 realizes a function as a communication unit.

The image capturing device (not shown) is an imaging element such as a CCD (Charge Coupled Device) or CMOS (Complementary Metal Oxide Semiconductor), and a device that captures an image of the real space using various elements such as lenses for controlling image formation of a subject on the imaging element to generate the captured image. The image capturing device may capture a still image or may capture a moving image.

The configuration and operation of the live streaming system 1 in the embodiment have been described. This embodiment is a mere example, and it is understood by those skilled in the art that various modifications are possible for each component and a combination of each process, and that such modifications are also within the scope of the present disclosure.

The processing and procedures described in the present disclosure may be realized by software, hardware, or any combination of these in addition to what was explicitly described. For example, the processing and procedures described in the specification may be realized by implementing a logic corresponding to the processing and procedures in a medium such as an integrated circuit, a volatile memory, a non-volatile memory, a non-transitory computer-readable medium and a magnetic disk. Further, the processing and procedures described in the specification can be implemented as a computer program corresponding to the processing and procedures, and can be executed by various kinds of computers.

Furthermore, the system or method described in the above embodiments may be integrated into programs stored in a computer-readable non-transitory medium such as a solid state memory device, an optical disk storage device, or a magnetic disk storage device. Alternatively, the programs may be downloaded from a server via the Internet and be executed by processors.

Although technical content and features of the present disclosure are described above, a person having common knowledge in the technical field of the present disclosure may still make many variations and modifications without disobeying the teaching and disclosure of the present disclosure. Therefore, the scope of the present disclosure is not limited to the embodiments that are already disclosed, but includes another variation and modification that do not disobey the present disclosure, and is the scope covered by the patent application scope.

What is claimed is:

1. A method for stream distribution, executed by a server, comprising:
comparing a first parameter associated between a distributor and a viewer with a first threshold;
comparing a second parameter associated between the distributor and the viewer with a second threshold; and
determining the viewer to be eligible or not for viewing a live stream performed by the distributor according to results of the above comparisons.

2. The method according to claim 1, further comprising:
determining the first parameter to be greater than the first threshold;
determining the second parameter to be less than the second threshold; and
determining the viewer to be eligible for viewing the live stream performed by the distributor.

3. The method according to claim 1, further comprising:
determining the first parameter to be greater than the first threshold;
determining the second parameter to be greater than the second threshold; and
determining the viewer to be not eligible for viewing the live stream performed by the distributor.

4. The method according to claim 2, further comprising:
notifying the viewer about a start of the live stream performed by the distributor.

5. The method according to claim 3, further comprising:
preventing the viewer from receiving a notification about a start of the live stream performed by the distributor.

6. The method according to claim 1, wherein the first parameter is a number of times the viewer has watched streaming of the distributor.

7. The method according to claim 1, further comprising:
obtaining a desirable viewer number for the live stream from the distributor; and
adjusting the first threshold and the second threshold according to the desirable viewer number.

8. The method according to claim 2, further comprising:
calculating a confidence score associated between the distributor and the viewer according to coexistence time between the viewer and another viewer in past streams of the distributor; and
determining the confidence score to be less than a third threshold,
wherein the another viewer has been determined to be active with respect to the distributor.

9. A system for stream distribution, comprising one or a plurality of processors, wherein the one or plurality of processors execute a machine-readable instruction to perform:
comparing a first parameter associated between a distributor and a viewer with a first threshold;
comparing a second parameter associated between the distributor and the viewer with a second threshold; and
determining the viewer to be eligible or not for viewing a live stream performed by the distributor according to results of the above comparisons.

10. A non-transitory computer-readable medium including a program for stream distribution, wherein the program causes one or a plurality of computers to execute:
comparing a first parameter associated between a distributor and a viewer with a first threshold;
comparing a second parameter associated between the distributor and the viewer with a second threshold; and
determining the viewer to be eligible or not for viewing a live stream performed by the distributor according to results of the above comparisons.
